(19) United States
(12) Patent Application Publication
(10) Pub. No.: US 2011/0291811 A1
(43) Pub. Date: Dec. 1, 2011

(54) INFORMATION PROCESSING DEVICE AND RECEIVING METHOD

(75) Inventors: Hiroaki Nakano, Tokyo (JP); Shinichi Fukuda, Kanagawa (JP); Kenichi Kabasawa, Saitama (JP)

(73) Assignee: SONY CORPORATION, Tokyo (JP)

(21) Appl. No.: 13/113,565

(22) Filed: May 23, 2011

(30) Foreign Application Priority Data
May 31, 2010 (JP) P2010-125022

(51) Int. Cl. H04Q 5/22

(52) U.S. Cl. 340/10.4

(57) ABSTRACT

A receiving method includes the steps of: performing contactless communication using a wireless antenna and electromagnetic coupling, subjecting a signal received by the wireless antenna in the communication step to IQ detection, subjecting the signal received by the wireless antenna in the communication step to ASK detection, firstly automatically controlling a gain for the signal subjected to the IQ detection in the IQ detection step, secondly automatically controlling a gain for the signal subjected to the ASK detection in the ASK detection step, performing predetermined demodulation processing on an output of the first AGC step or second AGC step, and receiving information of control voltage levels in the first AGC step and the second AGC step and controlling supply of one of the outputs of the first and second AGC steps to the demodulation step by switching between the outputs of the first and second AGC steps.

### CROSS-REFERENCE TO RELATED APPLICATION

The present application claims priority from Japanese Patent Application No. JP 2010-125022 filed in the Japanese Patent Office on May 31, 2010, the entire content of which is incorporated herein by reference.

### BACKGROUND OF THE INVENTION

1. Field of the Invention

The present invention relates to an information processing device and a receiving method.

2. Description of the Related Art

Contactless communication is a wireless technique in which data transmission is performed at a transmission distance ranging from 0 to tens of centimeters, and, for example, the contactless communication is applied to an RFID system including a contactless IC card and a reader/writer. Depending on the communication direction thereof, the contactless communication may be divided into two types of communication such as communication from the reader/writer to the card and communication from the card to the reader/writer. In any of the communication directions, the reader/writer constantly oscillates a carrier frequency, and the card performs transmission processing and reception processing on the basis of electric power obtained from the carrier frequency.

In recent years, a large number of mobile terminals such as IC cards, mobile phones, and the like having proximity communication functions have been used. For example, there has been FeliCa (registered trademark) that is an IC card developed by Sony Corporation. As a communication standard for proximity communication, for example, there is an NFC (Near Field Communication) standard that is a short-range wireless communication standard developed by Sony Corporation and Royal Philips Electronics.

For example, a carrier frequency of 13.56 MHz is used in the proximity communication, and communication is performed under the condition that a distance between a transmitter and a receiver ranges from contact (0 millimeter) to about 100 millimeters. The summary of the communication will be described with reference to FIG. 1A, FIG. 1B, FIG. 2A, and FIG. 2B. It may be assumed that there is magnetic coupling between a transmitting antenna and a receiving antenna functioning as coils, at this distance. The transmitting antenna and the receiving antenna are a pair of transformers.

FIG. 1A and FIG. 1B are explanatory diagrams illustrating processing in which data is transmitted from a reader/writer 10 to a transponder 20 such as, for example, an IC card or the like. FIG. 2A and FIG. 2B are explanatory diagrams illustrating processing in which data is transmitted from the transponder 20 to the reader/writer 10.

The processing in which data is transmitted from the reader/writer 10 to the transponder 20 such as, for example, an IC card or the like will be described with reference to FIG. 1A and FIG. 1B. As illustrated in FIG. 1A, the reader/writer 10 transmits a modulation signal (signal S1c) from a transmission amplifier to the transponder 20 through a coil, the modulation signal conveying transmission information (signal S1b) of 212 kbps on a carrier signal (signal S1a) of 13.56 MHz. The transponder 20 receives a reception signal (signal S1d) through a coil.

FIG. 1B illustrates a carrier signal waveform (signal S1a), a transmission information waveform (signal S1b), a transmission signal waveform (signal S1c), and a reception signal waveform (signal S1d). In addition, an ASK modulation (Amplitude Shift Keying) method is adopted as a modulation method.

The processing in which data is transmitted from the transponder 20 such as an IC card or the like to the reader/writer 10 will be described with reference to FIG. 2A and FIG. 2B. As illustrated in FIG. 2A, the reader/writer 10 transmits a carrier signal (signal S2a) of 13.56 MHz from a transmission amplifier to the transponder 20 through a coil. The transponder 20 transmits to the reader/writer 10 a transmission signal (signal S2c) generated by modulating transmission information (signal S2b) of 212 kbps. The reader/writer 10 receives a reception signal (signal S2d) through a coil.

FIG. 2B illustrates a carrier signal waveform (signal S2a), a transmission information waveform (signal S2b), a transmission signal waveform (signal S2c), and a reception signal waveform (signal S2d).

Between the reader/writer 10 and the transponder 20 illustrated in FIG. 1A and FIG. 2A, communication is performed under the condition that a distance between a transmitter and a receiver ranges from contact (0) to ten-some centimeters. It may be assumed that there occurs magnetic coupling between a transmitting antenna and a receiving antenna functioning as coils, at this distance. The transmitting antenna and the receiving antenna are a pair of transformers.

As described above, for example, in the contactless communication using the NFC standard applied to FeliCa (registered trademark) that is an IC card developed by Sony Corporation, or the like, communication is performed, using a carrier of 13.56 MHz, under the condition that a distance between a transmitter and a receiver ranges from contact (0 millimeter) to about 100 millimeters. Accordingly, it is necessary to stably perform communication even if an inter-antenna distance between the R/W and the card is relatively large or an antenna positional relationship greatly changes during communication.

In the communication from the transponder 20 such as the IC card or the like to the reader/writer 10, a modulation method, called a load modulation method, is adopted. The method is a technique in which a diamagnetic field is generated by turning on and off a load in the transponder 20 such as the IC card or the like and the reader/writer 10 recognizes (detects) the change thereof, thereby allowing modulation to be confirmed.

As one of major problems of the load modulation method, there is a problem called phase inversion NULL. FIG. 3 is an explanatory diagram illustrating with a graph the principle of the occurrence of the inversion NULL in contactless communication. The problem of the phase inversion NULL is a possibility that a situation occurs in which an amplitude component is not modulated before and after a load on the transponder 20 side such as the IC card or the like is turned on and off. In this case, even if the amplitude component is detected, it is difficult to confirm a modulation component.

FIG. 4A to FIG. 4C are explanatory diagrams illustrating waveforms obtained by observing the reception baseband waveform (after-detection waveform) of the reader/writer 10. FIG. 4A illustrates a waveform when a distance between the reader/writer 10 and the transponder 20 is 50 millimeters, FIG. 4B illustrates a waveform when a distance between the reader/writer 10 and the transponder 20 is 70 millimeters, and FIG. 4C illustrates a waveform when a distance between the reader/writer 10 and the transponder 20 is 85 millimeters.

As illustrated in FIG. 4A to FIG. 4C, it can be confirmed that a waveform disappears from view at a point the distance of which is 70 millimeters and a waveform is inversed around the point the distance of which is 70 millimeters. This is the problem called phase inversion NULL. An example of techniques for dealing with the phase inversion NULL is Japanese Unexamined Patent Application Publication No. 2009-175976. Japanese Unexamined Patent Application Publication No. 2009-175976 discloses a technique in which the phase inversion NULL is solved by changing the Q-value of an antenna.

### SUMMARY OF THE INVENTION

However, there has been a problem that there is a higher risk when the Q-value of an antenna is adjusted in order to solve the phase inversion NULL. The Q-value is an important parameter for maintaining a communication distance or maintaining a communication waveform. However, when the technique disclosed in Japanese Unexamined Patent Application Publication No. 2009-175976 is used, there is a possibility that a communication distance or communication quality is adversely affected owing to the Q-value changed in order to solve the phase inversion NULL.

In addition, depending on the combination of a reader/writer and a contactless IC card, the Q-value and an f₀ value vary greatly. In addition, in a device such as a mobile phone, in which metal is mounted, the visibility of the metal varies in a near portion and a distant portion, and the Q-value and the f₀ value vary. It is not necessarily the case that the technique disclosed in Japanese Unexamined Patent Application Publication No. 2009-175976 is universally applicable to the combinations of large numbers of reader/writers and contactless IC cards.

Accordingly, it is necessary to solve the phase inversion NULL using another technique so that the other technique is universally applicable to the combinations of large numbers of reader/writers and contactless IC cards. The simplest way is a technique in which, using an IQ detection (orthogonal detection), not only is an amplitude component detected but a phase component is also simultaneously detected. Owing to the use of the IQ detection, even if the amplitude component disappears, a signal can be detected using the change of the phase component.

However, the IQ detection also has a problem due to a load modulation method particular to contactless communication. Since, unlike ASK detection, the IQ detection uses an active element, an input dynamic range turns out to be determined on the basis of a power-supply voltage and a withstand voltage. Since a reader/writer in the contactless communication performs load modulation reception, a reception signal reaches tens of voltages depending on the kind of a system, in some cases. In addition, in this case, in order to perform the IQ detection, it is necessary to reduce a voltage to at least the power-supply voltage or less (the input dynamic range of an IC or less) using resistance division. When a carrier level is reduced with resistance division, a modulation signal naturally decreases in proportion, and a signal-noise (SN) ratio decreases. Owing to the load modulation method, a modulation degree becomes small with communication distance being increased, and a carrier signal level monotonically increases with decrease in the modulation degree. Accordingly, when the SN ratio severely decreases, further resistance division is necessary. Therefore, there occurs a problem that the communication distance becomes short compared with the ASK detection.

Therefore, embodiments of the present invention address the above-mentioned problems. In addition, according to an embodiment of the present invention, it is desirable to provide an information processing device and a receiving method that are new and improved which, even at a communication distance causing the phase inversion NULL to occur, can solve a communication error and adequately perform contactless communication, by adequately switching between the IQ detection and the ASK detection.

In order to solve the above-mentioned problems, according to one of viewpoints of an embodiment of the present invention, there is provided an information processing device including a wireless antenna configured to perform contactless communication using electromagnetic coupling, an IQ detection unit configured to subject a signal received by the wireless antenna to IQ detection, an ASK detection unit configured to subject the signal received by the wireless antenna to ASK detection, a first AGC circuit configured to control a gain for the signal subjected to the IQ detection by the IQ detection unit, a second AGC circuit configured to control a gain for the signal subjected to the ASK detection by the ASK detection unit, a demodulation circuit configured to perform predetermined demodulation processing on an output of the first AGC circuit or an output of the second AGC circuit, and a control unit configured to receive information of control voltage levels from the first AGC circuit and the second AGC circuit, and control, in response to the information of the control voltage levels, supply of one of the outputs of the first AGC circuit and the second AGC circuit to the demodulation circuit, by switching between the outputs of the first AGC circuit and the second AGC circuit.

The control unit may control, on the basis of whether or not the control voltage level from the second AGC circuit is less than a predetermined threshold value, supply of one of the outputs of the first AGC circuit and the second AGC circuit to the demodulation circuit, by switching between the outputs of the first AGC circuit and the second AGC circuit.

The control unit may control the supply so that the output of the second AGC circuit is supplied to the demodulation circuit when the control voltage level from the second AGC circuit is less than a predetermined threshold value and the output of the first AGC circuit is supplied to the demodulation circuit when the control voltage level from the second AGC circuit is greater than or equal to the predetermined threshold value.

The control unit may control the supply so that the output of the second AGC circuit is supplied to the demodulation circuit when the control voltage level from the second AGC circuit is less than the control voltage level from the first AGC circuit and the output of the first AGC circuit is supplied to the demodulation circuit when the control voltage level from the second AGC circuit is greater than or equal to the control voltage level from the first AGC circuit.

The control unit may control the supply so that the control unit switches to an output, which has not been selected, and supplies the output to the demodulation circuit, when a demodulation error occurs in demodulation processing performed in the demodulation circuit.

The information processing device further includes a first switch configured to be provided between the first AGC circuit and the demodulation circuit, and a second switch configured to be provided between the second AGC circuit and the demodulation circuit, wherein the control unit may switch between the outputs of the first AGC circuit and the second AGC circuit and supply one of the outputs of the first AGC circuit and the second AGC circuit to the demodulation circuit, by switching over the first switch and the second switch.

The information processing device further includes a third switch configured to be provided between the wireless antenna and the first AGC circuit, and a fourth switch configured to be provided between the wireless antenna and the second AGC circuit, wherein the control unit may switch between the outputs of the first AGC circuit and the second AGC circuit and supply one of the outputs of the first AGC circuit and the second AGC circuit to the demodulation circuit, by switching over the third switch and the fourth switch.

In order to solve the above-mentioned problems, according to another of viewpoints of an embodiment of the present invention, there is provided a receiving method including the steps of: performing contactless communication using a wireless antenna and electromagnetic coupling, subjecting a signal received by the wireless antenna in the communication step to IQ detection, subjecting the signal received by the wireless antenna in the communication step to ASK detection, firstly automatically controlling a gain for the signal subjected to the IQ detection in the IQ detection step, secondly automatically controlling a gain for the signal subjected to the ASK detection in the ASK detection step, performing predetermined demodulation processing on an output of the first AGC step or an output of the second AGC step, and receiving information of control voltage levels in the first AGC step and the second AGC step and controlling, in response to the information of the control voltage levels, supply of one of the outputs of the first AGC step and the second AGC step to the demodulation step, by switching between the outputs of the first AGC step and the second AGC step.

### BRIEF DESCRIPTION OF THE DRAWINGS

FIG. 1A is an explanatory diagram illustrating processing in which data is transmitted from a reader/writer to a transponder such as, for example, an IC card or the like;

FIG. 1B is an explanatory diagram illustrating processing in which data is transmitted from the reader/writer to the transponder such as, for example, an IC card or the like;

FIG. 2A is an explanatory diagram illustrating processing in which data is transmitted from the transponder to the reader/writer;

FIG. 2B is an explanatory diagram illustrating processing in which data is transmitted from the transponder to the reader/writer;

FIG. 3 is an explanatory diagram illustrating with a graph a principle of the occurrence of inversion NULL in contactless communication;

FIG. 4A is an explanatory diagram illustrating waveforms obtained by observing a reception baseband waveform (after-detection waveform) of the reader/writer;

FIG. 4B is an explanatory diagram illustrating waveforms obtained by observing a reception baseband waveform (after-detection waveform) of the reader/writer;

FIG. 4C is an explanatory diagram illustrating waveforms obtained by observing a reception baseband waveform (after-detection waveform) of the reader/writer;

FIG. 5 is an explanatory diagram illustrating a configuration of a reader/writer according to an embodiment of the present invention;

FIG. 6A is an explanatory diagram illustrating a measurement example of a relationship between a control voltage level for AGC and a communication distance;

FIG. 6B is an explanatory diagram illustrating a measurement example of a relationship between a control voltage level for AGC and a communication distance;

FIG. 6C is an explanatory diagram illustrating a measurement example of a relationship between a control voltage level for AGC and a communication distance;

FIG. 6D is an explanatory diagram illustrating a measurement example of a relationship between a control voltage level for AGC and a communication distance;

FIG. 7 is a flowchart illustrating an example of an operation performed in the reader/writer according to an embodiment of the present invention;

FIG. 8 is a flowchart illustrating an example of an operation performed in the reader/writer according to an embodiment of the present invention;

FIG. 9 is a flowchart illustrating an example of an operation performed in the reader/writer according to an embodiment of the present invention;

FIG. 10 is an explanatory diagram illustrating an example of a configuration of the reader/writer according to an embodiment of the present invention; and

FIG. 11 is an explanatory diagram illustrating an example of a configuration of the reader/writer according to an embodiment of the present invention.

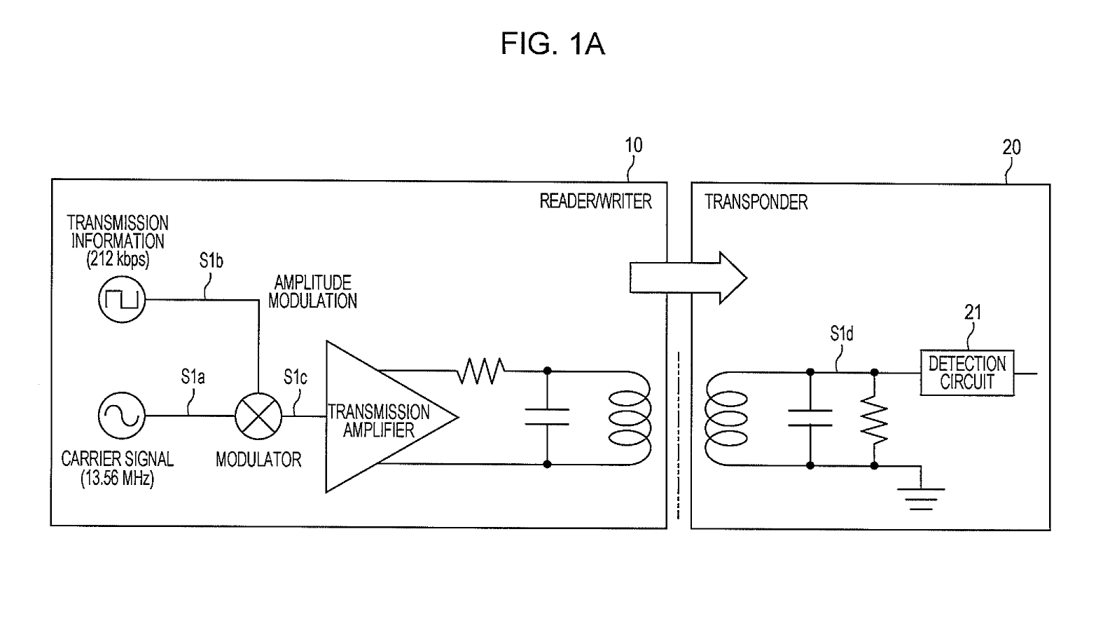

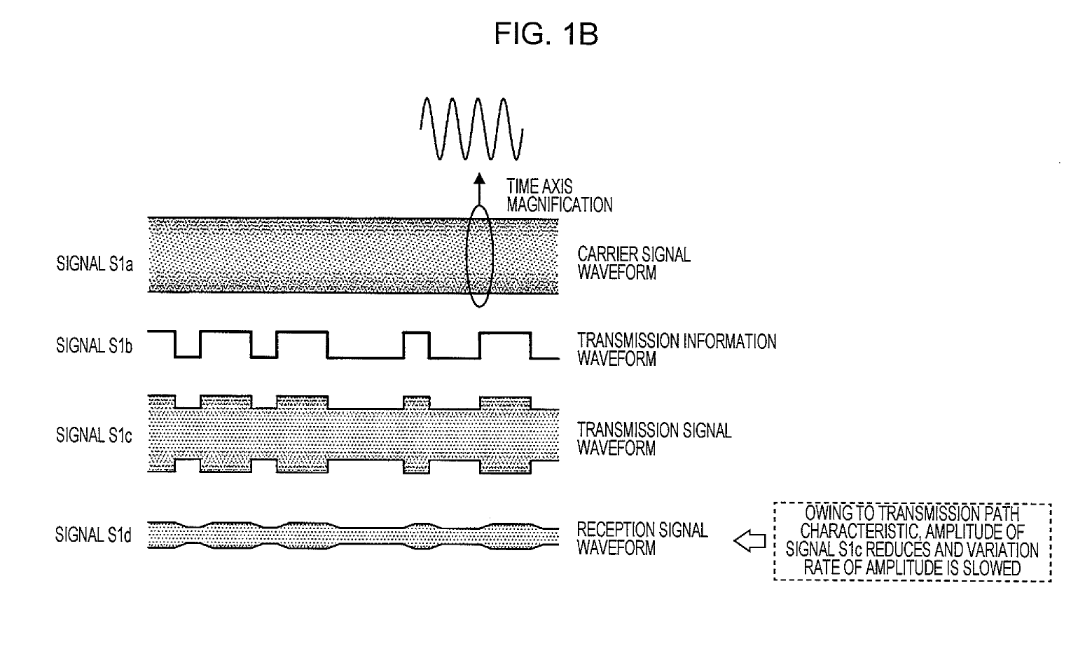

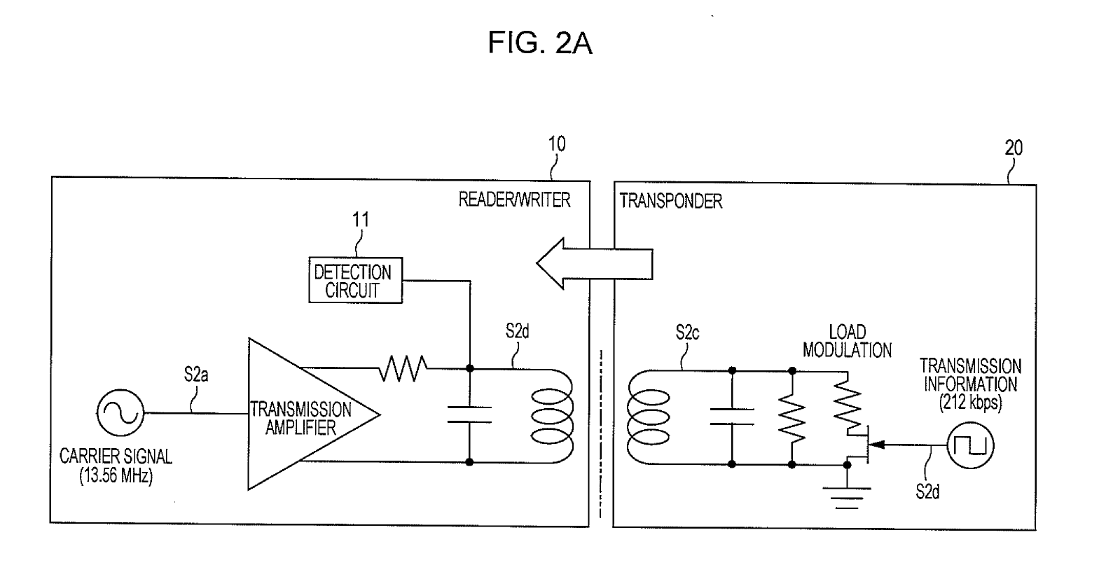

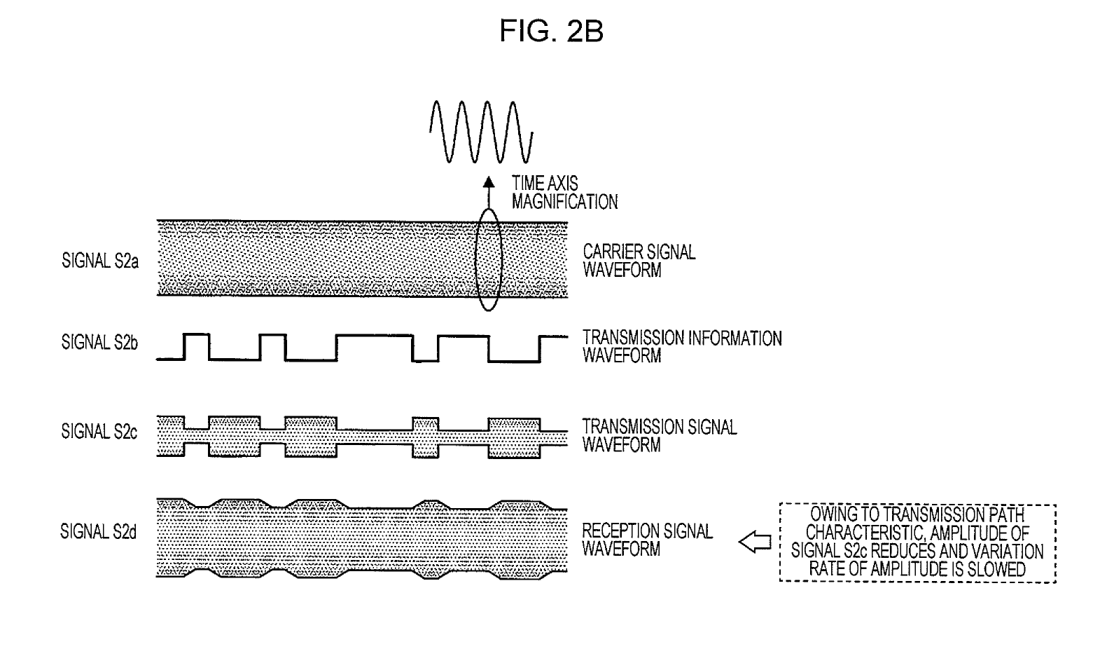

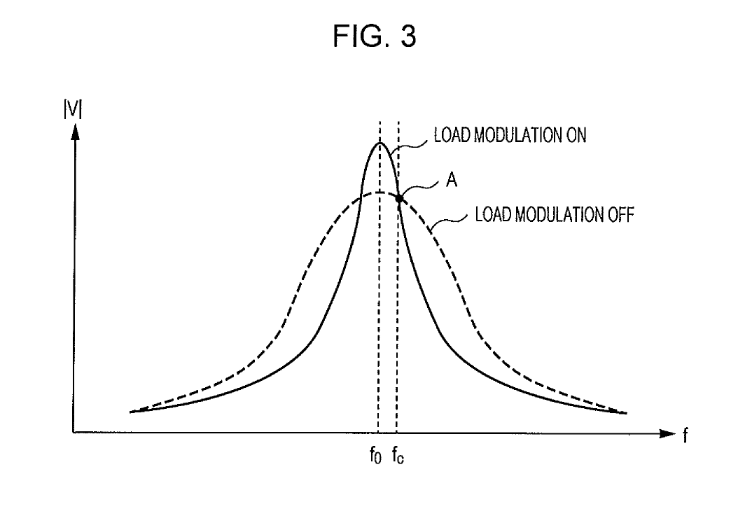

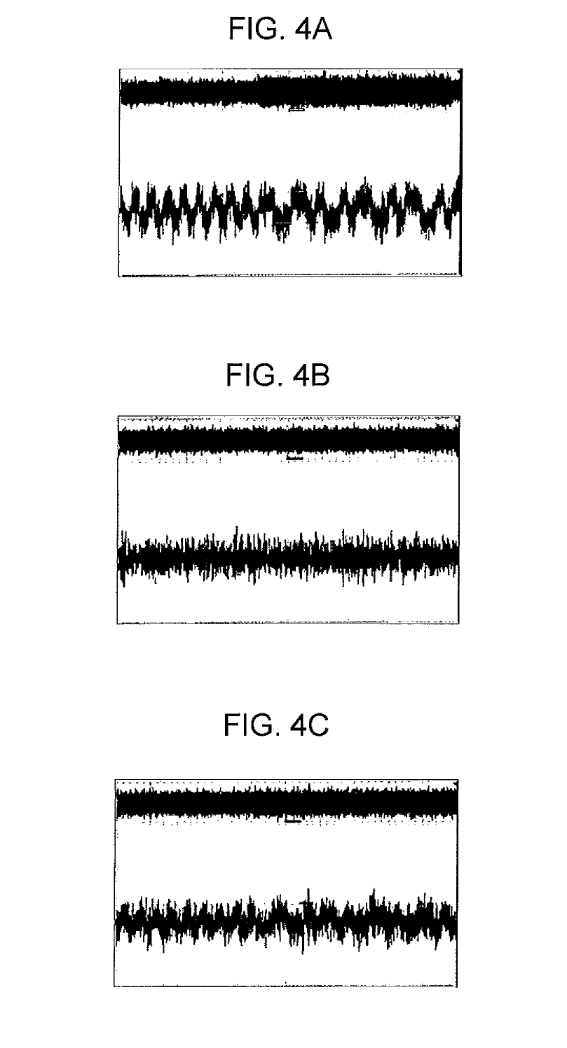

### DESCRIPTION OF THE PREFERRED EMBODIMENTS

Hereinafter, preferred embodiments of the present invention will be described in detail with reference to figures. In addition, in the present application and figures, a same symbol is assigned to a constructional element having substantially the same function and configuration, and the redundant description thereof will be omitted.

In addition, the preferred embodiments will be described in the following order.

<1. Embodiment of Present Invention>
[1-1. Configuration of Reader/Writer]
[1-2. Operation Performed in Reader/Writer]
[1-3. Example of Modification to Reader/Writer]

<2. Summary>

### 1. Embodiment of Present Invention

### [1-1. Configuration of Reader/Writer]

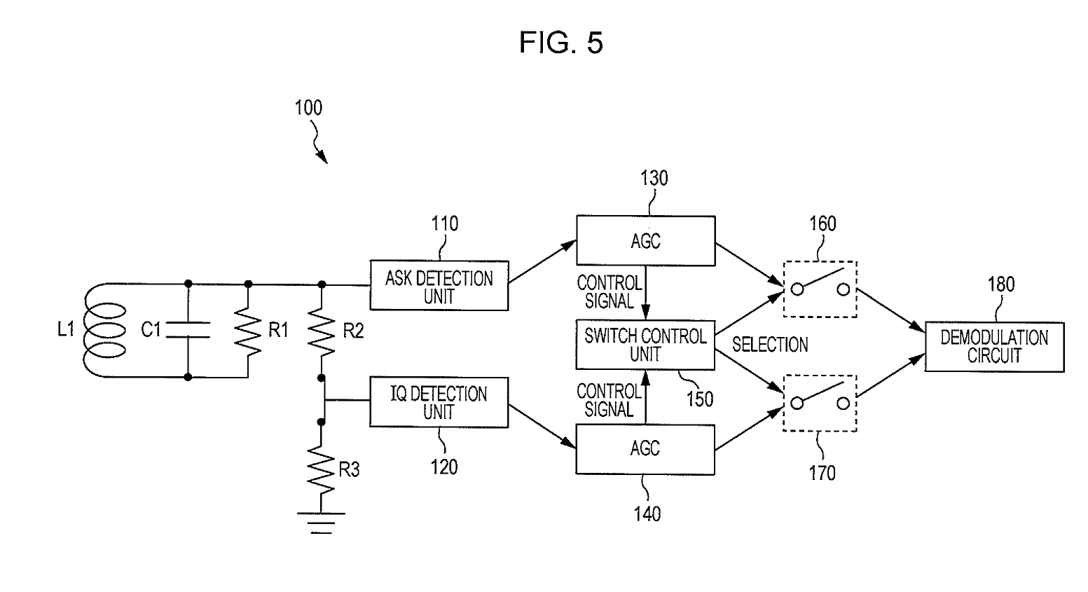

First, the configuration of a reader/writer according to an embodiment of the present invention will be described. FIG. 5 is an explanatory diagram illustrating the configuration of a reader/writer 100 according to an embodiment of the present invention. The reader/writer 100 illustrated in FIG. 5 performs the above-mentioned contactless communication with a mobile phone or the like (not illustrated. These devices are simply called “contactless IC card” hereinafter) in which a contactless IC card or an antenna coil is embedded, and thereby transmits and receives information to and from the contactless IC card. Hereinafter, the configuration of the reader/writer 100 according to an embodiment of the present invention will be described with reference to FIG. 5.

As illustrated in FIG. 5, the reader/writer 100 according to an embodiment of the present invention includes an ASK detection unit 110, an IQ detection unit 120, automatic gain control (AGC) circuits 130 and 140, a switch control unit 150, switches 160 and 170, a demodulation circuit 180, an antenna coil L1, a capacitor C1, and resistors R1, R2, and R3.

The ASK detection unit 110 executes ASK detection processing in which an amplitude component is detected for a signal received from the contactless IC card by the antenna coil L1. The output of the ASK detection processing performed by the ASK detection unit 110 is sent to the AGC circuit 130.

The IQ detection unit 120 executes IQ detection processing in which both an amplitude component and a phase component are detected for the signal received from the contactless IC card by the antenna coil L1. The output of the IQ detection processing performed by the IQ detection unit 120 is sent to the AGC circuit 140.

The AGC circuit 130 adjusts the output of the ASK detection unit 110 so that the output has a predetermined gain, and outputs the output. In the same way, the AGC circuit 140 adjusts the output of the IQ detection unit 120 so that the output has a predetermined gain, and outputs the output. Signals the gains of which are adjusted by the AGC circuits 130 and 140 are sent to the demodulation circuit 180 through the switches 160 and 170, respectively. In addition, the information of a control voltage level for AGC is sent from each of the AGC circuits 130 and 140 to the switch control unit 150. The information of a control voltage level for AGC, sent from each of the AGC circuits 130 and 140, is used for causing the switch control unit 150 to determine whether the switch 160 or the switch 170 is to be put into an on-state.

On the basis of the information of a control voltage level for AGC, sent from each of the AGC circuits 130 and 140, the switch control unit 150 executes a control operation in which one of the switches 160 and 170 is put into an on-state. In order to put one of the switches 160 and 170 into an on-state, the switch control unit 150 determines whether or not the control voltage level for AGC after the IQ detection performed in the IQ detection unit 120 is less than a predetermined threshold value, for example.

When the control voltage level for AGC after the IQ detection performed in the IQ detection unit 120 is less than the predetermined threshold value, the switch control unit 150 uses the IQ detection, namely puts the switch 160 into an off-state and puts the switch 170 into an on-state. On the other hand, when the control voltage level for AGC after the IQ detection performed in the IQ detection unit 120 is greater than or equal to the predetermined threshold value, the switch control unit 150 uses the ASK detection, namely puts the switch 160 into an on-state and puts the switch 170 into an off-state.

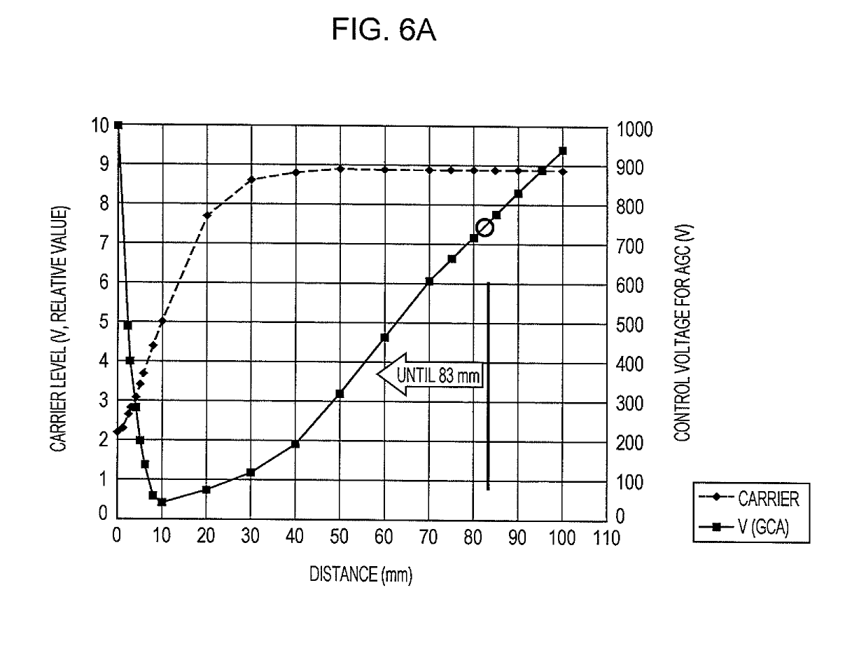

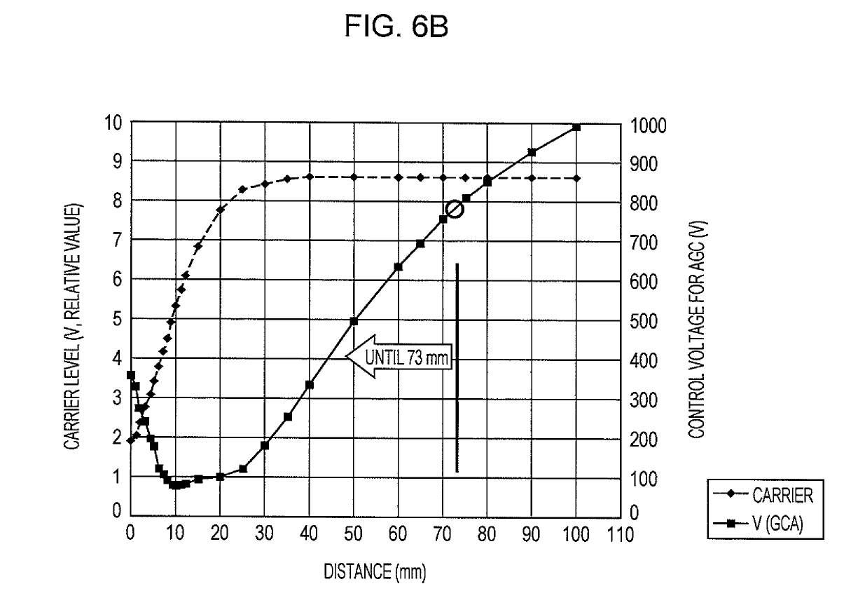

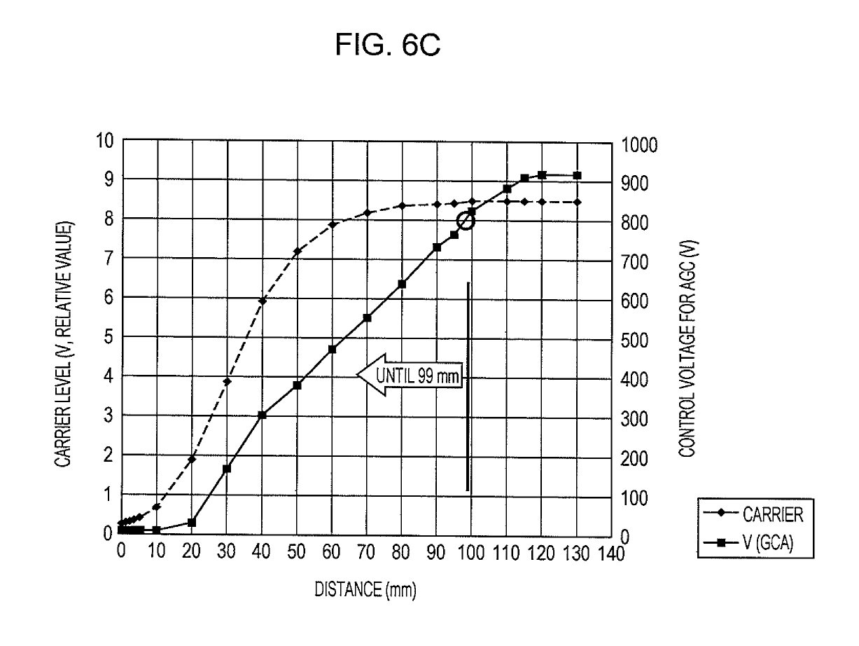

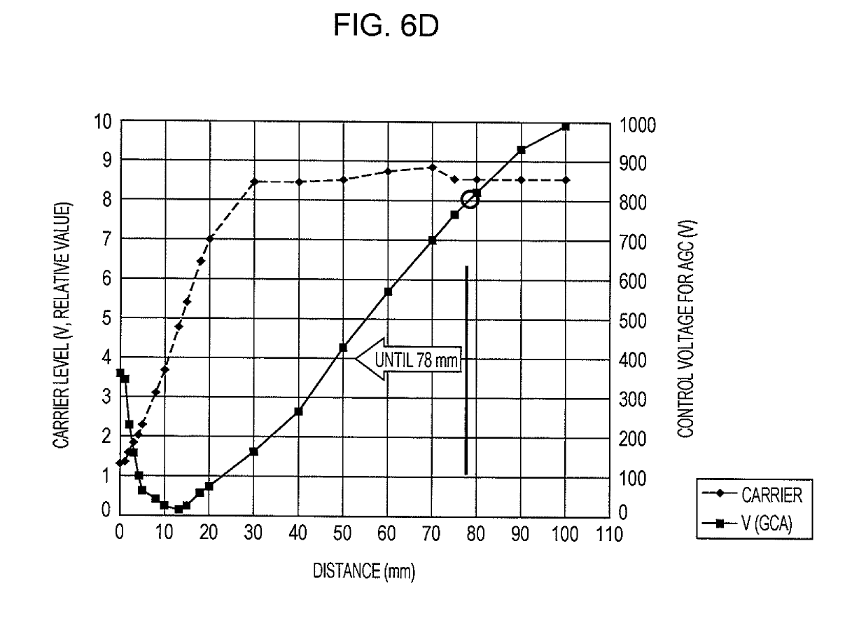

FIG. 6A to FIG. 6D are explanatory diagrams illustrating measurement examples of a relationship between a control voltage level for AGC and a communication distance. In each of the graphs illustrated in FIG. 6A to FIG. 6D, a horizontal axis indicates a distance between a contactless IC card and a reader/writer, and a vertical axis indicates a relative value of a carrier level.

As illustrated in FIG. 6A to FIG. 6D, a communication error occurs when the AGC control voltage level of the IQ detection reaches a voltage ranging from about 730 mV to about 830 mV. Namely, on the basis of an actual measurement result, it may be considered that, for example, a threshold value is set to 700 mV (namely, when the AGC control voltage level of the IQ detection becomes greater than or equal to 700 mV, detection is switched to an ASK detection), thereby allowing communication to be successfully performed between the contactless IC card and the reader/writer. Needless to say, an example of the threshold value is not limited to such an example described above.

In this way, depending on whether or not the control voltage level for AGC after the IQ detection performed in the IQ detection unit 120 is greater than or equal to the predetermined threshold value, the reader/writer 100 according to an embodiment of the present invention selects one of the ASK detection and the IQ detection. Accordingly, even in a situation in which phase inversion NULL occurs, the reader/writer 100 according to an embodiment of the present invention can normally perform contactless communication with the contactless IC card.

As described above, the switches 160 and 170 are switches the on-off states of which are controlled by the switch control unit 150. When the switch 160 is put into an on-state by the switch control unit 150, and the switch 170 is put into an off-state by the switch control unit 150, an output from the AGC circuit 130 is supplied to a demodulation circuit in a subsequent stage. On the other hand, when the switch 160 is put into an off-state by the switch control unit 150, and the switch 170 is put into an on-state by the switch control unit 150, an output from the AGC circuit 140 is supplied to the demodulation circuit in a subsequent stage.

The demodulation circuit 180 receives the output from the AGC circuit 130 or the AGC circuit 140, and executes predetermined demodulation processing. The demodulation circuit 180 demodulates a signal modulated on the contactless IC card side, and can extract information on the basis of demodulation processing performed in the demodulation circuit 180.

The reader/writer 100 according to an embodiment of the present invention includes a configuration illustrated in FIG. 5, and hence, even at a communication distance causing phase inversion NULL to occur, the reader/writer 100 can solve a communication error and adequately perform contactless communication with the contactless IC card, by adequately switching between ASK detection and IQ detection.

As described above, the configuration of the reader/writer 100 according to an embodiment of the present invention has been described with reference to FIG. 5. Next, an operation, performed in the reader/writer 100 illustrated in FIG. 5 according to an embodiment of the present invention, will be described.

### [1-2. Operation Performed in Reader/Writer]

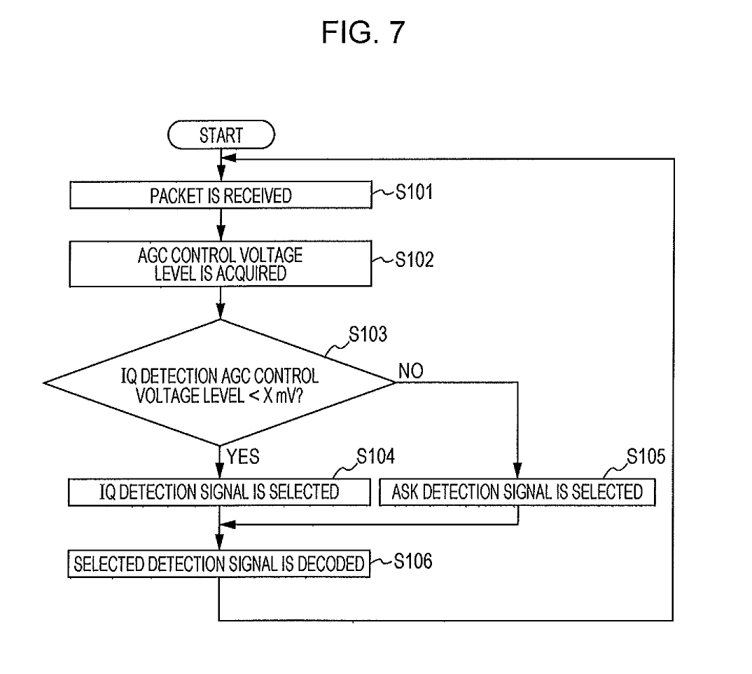

FIG. 7 is a flowchart illustrating an example of the operation performed in the reader/writer 100 according to an embodiment of the present invention. Hereinafter, the operation performed in the reader/writer 100 according to an embodiment of the present invention will be described with reference to FIG. 7.

First, the reader/writer 100 receives a packet from the contactless IC card with the antenna coil L1, using contactless communication (Step S101). In the reader/writer 100, the ASK detection unit 110 and the IQ detection unit 120 concurrently perform an ASK detection processing and an IQ detection processing on the packet received with the antenna coil L1, respectively.

The AGC circuit 130 adjusts the output of the ASK detection unit 110 so that the output has a predetermined gain, and outputs the output. In the same way, the AGC circuit 140 adjusts the output of the IQ detection unit 120 so that the output has a predetermined gain, and outputs the output. In addition, the switch control unit 150 acquires a control voltage level for AGC from each of the AGC circuits 130 and 140 (Step S102).

When the switch control unit 150 acquires the control voltage level for AGC from each of the AGC circuits 130 and 140, the switch control unit 150 determines whether or not the AGC control voltage level of the IQ detection is less than a predetermined threshold value (X m [V]) (Step S103).

In a case in which, on the basis of the determination result obtained in the above-mentioned Step S103, it is determined that the AGC control voltage level of the IQ detection is less than the predetermined threshold value (X m [V]), since a baseband signal becomes small owing to phase inversion NULL, the switch control unit 150 controls switches so that an IQ detection signal is selected (Step S104). Specifically, the switch control unit 150 puts the switch 160 into an off-state and puts the switch 170 into an on-state, thereby controlling switches so that the IQ detection signal is supplied to the demodulation circuit 180.

On the other hand, when, on the basis of the determination result obtained in the above-mentioned Step S103, it is determined that the AGC control voltage level of the IQ detection is greater than or equal to the predetermined threshold value (X m [V]), the switch control unit 150 controls switches so that an ASK detection signal is selected (Step S105). Specifically, the switch control unit 150 puts the switch 160 into an on-state and puts the switch 170 into an off-state, thereby controlling switches so that the ASK detection signal is supplied to the demodulation circuit 180.

When, on the basis of the above-mentioned Steps S104 and S105, the switch control unit 150 controls the on-off states of the switches 160 and 170, and one of the ASK detection signal and the IQ detection signal is supplied to the demodulation circuit 180, the demodulation circuit 180 executes predetermined demodulation processing and decodes a signal (Step S106).

As described above, the operation performed in the reader/writer 100 according to an embodiment of the present invention has been described with reference to FIG. 7. On the basis of the sequence of operations described above, even in a state in which the phase inversion NULL occurs, the reader/writer 100 can normally perform contactless communication with the contactless IC card, by adequately switching between ASK detection and IQ detection.

In addition, while, in the example illustrated in FIG. 7, depending on whether or not the AGC control voltage level of the IQ detection is less than the predetermined threshold value (X m [V]), the switch control unit 150 controls the on-off states of the switches 160 and 170 so that one of the ASK detection signal and the IQ detection signal is selected, an embodiment of the present invention is not limited to the example. For example, there is also a method in which the AGC control voltage level of the ASK detection is compared with the AGC control voltage level of the IQ detection and a detection signal having a smaller control voltage level (a detection signal having a greater baseband signal level) is selected. Next, another example of an operation performed in the reader/writer 100 according to an embodiment of the present invention will be described.

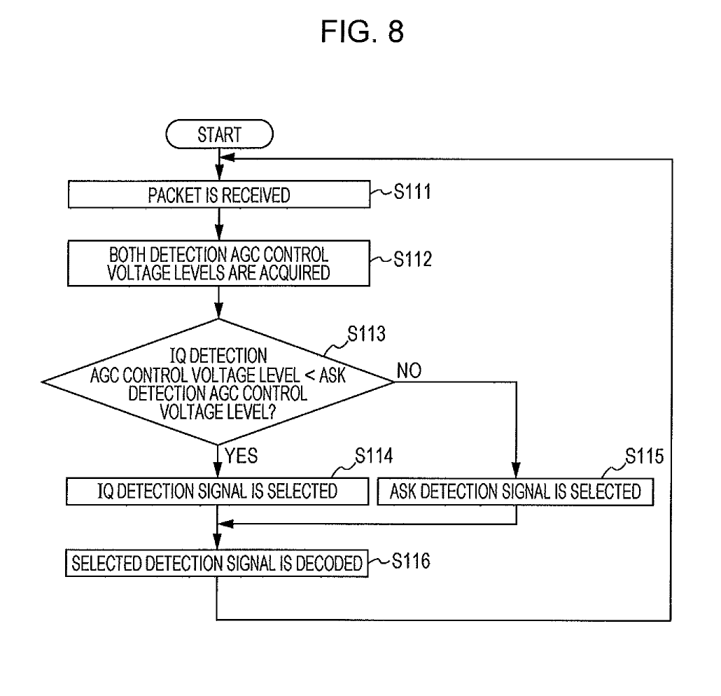

FIG. 8 is a flowchart illustrating another example of an operation performed in the reader/writer 100 according to an embodiment of the present invention. Hereinafter, the operation performed in the reader/writer 100 according to an embodiment of the present invention will be described with reference to FIG. 8.

First, the reader/writer 100 receives a packet from the contactless IC card with the antenna coil L1, using contactless communication (Step S111). In the reader/writer 100, the ASK detection unit 110 and the IQ detection unit 120 concurrently perform an ASK detection processing and an IQ detection processing on the packet received with the antenna coil L1, respectively.

The AGC circuit 130 adjusts the output of the ASK detection unit 110 so that the output has a predetermined gain, and outputs the output. In the same way, the AGC circuit 140 adjusts the output of the IQ detection unit 120 so that the output has a predetermined gain, and outputs the output. In addition, the switch control unit 150 acquires a control voltage level for AGC from each of the AGC circuits 130 and 140 (Step S112).

When the switch control unit 150 acquires the control voltage level for AGC from each of the AGC circuits 130 and 140, the switch control unit 150 determines whether or not the AGC control voltage level of the IQ detection is less than the AGC control voltage level of the ASK detection (Step S113).

When, on the basis of the determination result obtained in the above-mentioned Step S113, it is determined that the AGC control voltage level of the IQ detection is less than the AGC control voltage level of the ASK detection, the switch control unit 150 controls switches so that the IQ detection signal is selected (Step S114). Specifically, the switch control unit 150 puts the switch 160 into an off-state and puts the switch 170 into an on-state, thereby controlling switches so that the IQ detection signal is supplied to the demodulation circuit 180.

On the other hand, when, on the basis of the determination result obtained in the above-mentioned Step S113, it is determined that the AGC control voltage level of the IQ detection is greater than or equal to the AGC control voltage level of the ASK detection, the switch control unit 150 controls switches so that an ASK detection signal is selected (Step S115). Specifically, the switch control unit 150 puts the switch 160 into an on-state and puts the switch 170 into an off-state, thereby controlling switches so that the ASK detection signal is supplied to the demodulation circuit 180.

When, on the basis of the above-mentioned Steps S114 and S115, the switch control unit 150 controls the on-off states of the switches 160 and 170, and one of the ASK detection signal and the IQ detection signal is supplied to the demodulation circuit 180, the demodulation circuit 180 executes predetermined demodulation processing and decodes a signal (Step S116).

As described above, the operation performed in the reader/writer 100 according to an embodiment of the present invention has been described with reference to FIG. 8. On the basis of the sequence of operations described above, even in a state in which the phase inversion NULL occurs, the reader/writer 100 can normally perform contactless communication with the contactless IC card, by adequately switching between ASK detection and IQ detection.

In addition, at the time of switching between the ASK detection and the IQ detection, an SN ratio based on an AGC control signal may be calculated with respect to each of the AGC circuits 130 and 140, and information of the calculated SN ratio may be used. For example, at the time of the calculation of the SN ratio, a gain control signal for the AGC circuit, generated in response to a reception signal level, may be input, and the SN ratio of a reception signal may be calculated in response to the gain control signal.

In addition, while, in the example illustrated in FIG. 8, depending on whether or not the AGC control voltage level of the IQ detection is less than AGC control voltage level of the ASK detection, the reader/writer 100 adequately switches between the ASK detection and the IQ detection, the reader/writer 100 may switch to a detection signal that has not been selected, and perform demodulation, when an error occurs at the time of the demodulation of a selected detection signal. The ASK detection and the IQ detection have waveform qualities different from each other. Therefore, for example, when a demodulation error occurs mainly in a state in which the reader/writer and the contactless IC card are adjacent to each other, there is a possibility that, by decoding a signal using a different detection method at the time of retry, proximity contactless communication becomes available.

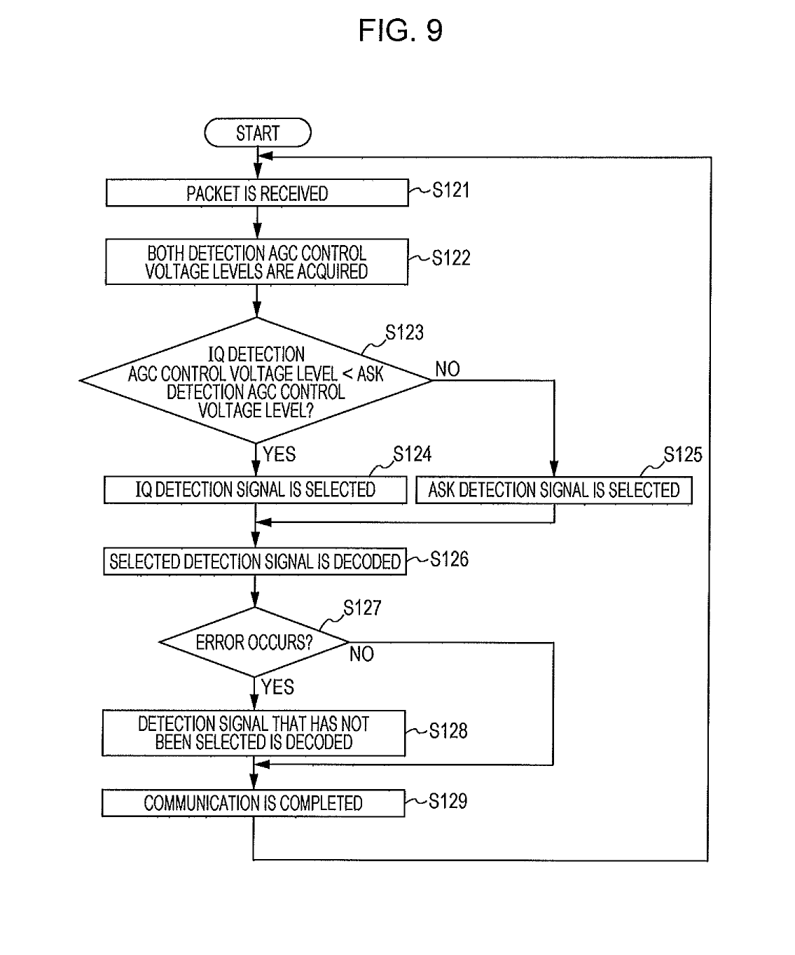

FIG. 9 is a flowchart illustrating another example of an operation performed in the reader/writer 100 according to an embodiment of the present invention. Hereinafter, the operation performed in the reader/writer 100 according to an embodiment of the present invention will be described with reference to FIG. 9.

First, the reader/writer 100 receives a packet from the contactless IC card with the antenna coil L1, using contactless communication (Step S121). In the reader/writer 100, the ASK detection unit 110 and the IQ detection unit 120 concurrently perform an ASK detection processing and an IQ detection processing on the packet received with the antenna coil L1, respectively.

The AGC circuit 130 adjusts the output of the ASK detection unit 110 so that the output has a predetermined gain, and outputs the output. In the same way, the AGC circuit 140 adjusts the output of the IQ detection unit 120 so that the output has a predetermined gain, and outputs the output. In addition, the switch control unit 150 acquires a control voltage level for AGC from each of the AGC circuits 130 and 140 (Step S122).

When the switch control unit 150 acquires the control voltage level for AGC from each of the AGC circuits 130 and 140, the switch control unit 150 determines whether or not the AGC control voltage level of the IQ detection is less than the AGC control voltage level of the ASK detection (Step S123).

When, on the basis of the determination result obtained in the above-mentioned Step S123, it is determined that the AGC control voltage level of the IQ detection is less than the AGC control voltage level of the ASK detection, the switch control unit 150 controls switches so that the IQ detection signal is selected (Step S124). Specifically, the switch control unit 150 puts the switch 160 into an off-state and puts the switch 170 into an on-state, thereby controlling switches so that the IQ detection signal is supplied to the demodulation circuit 180.

On the other hand, when, on the basis of the determination result obtained in the above-mentioned Step S123, it is determined that the AGC control voltage level of the IQ detection is greater than or equal to the AGC control voltage level of the ASK detection, the switch control unit 150 controls switches so that an ASK detection signal is selected (Step S125). Specifically, the switch control unit 150 puts the switch 160 into an on-state and puts the switch 170 into an off-state, thereby controlling switches so that the ASK detection signal is supplied to the demodulation circuit 180.

When, on the basis of the above-mentioned Steps S124 and S125, the switch control unit 150 controls the on-off states of the switches 160 and 170, and one of the ASK detection signal and the IQ detection signal is supplied to the demodulation circuit 180, the demodulation circuit 180 executes predetermined demodulation processing and decodes a signal (Step S126).

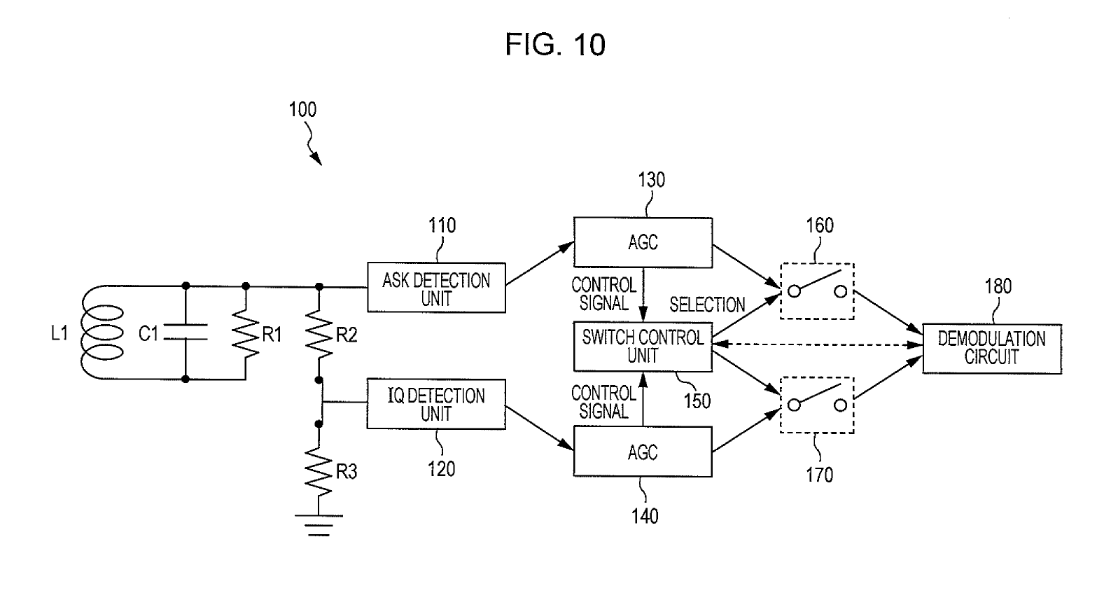

Here, the demodulation circuit 180 determines whether or not a demodulation error occurs at the time of the execution of demodulation processing (Step S127), and when a demodulation error occurs, the demodulation circuit 180 switches to a detection signal that has not been selected in the above-mentioned Step S126, and performs decoding (Step S128). Therefore, as illustrated in FIG. 10, the reader/writer 100 may include a configuration in which the presence or absence of a demodulation error is fed back from the demodulation circuit 180 to the switch control unit 150.

When, in the above-mentioned Step S127, it is determined that no demodulation error occurs in the demodulation processing performed in the demodulation circuit 180, or when, in the above-mentioned Step S127, it is determined that an demodulation error occurs in the demodulation processing performed in the demodulation circuit 180, and, in the above-mentioned Step S128, the demodulation circuit 180 switches to a detection signal that has not been selected in the above-mentioned Step S126, and performs decoding, the reader/writer 100 completes a sequence of communication processing operations (Step S129), and returns to the processing in which a packet is received from the contactless IC card, again.

As described above, the operation performed in the reader/writer 100 according to an embodiment of the present invention has been described with reference to FIG. 9. On the basis of the sequence of operations described above, even in a state in which the phase inversion NULL occurs, the reader/writer 100 can normally perform contactless communication with the contactless IC card, by adequately switching between the ASK detection and the IQ detection. In addition, when a detection signal is demodulated on the basis of the selected detection, and an error occurs, the reader/writer 100 switches to a detection signal that has not been selected and performs demodulation, thereby allowing proximity contactless communication to be available.

### [1-3. Example of Modification to Reader/Writer]

Next, an example of a modification to the reader/writer 100 according to an embodiment of the present invention will be described. In the above-mentioned reader/writer 100 according to an embodiment of the present invention, depending on whether or not the AGC control voltage level of the IQ detection is less than the predetermined threshold value (X m [V]) or whether or not the AGC control voltage level of the IQ detection is less than AGC control voltage level of the ASK detection, switching between the ASK detection and the IQ detection is adequately performed. The example of a modification to the reader/writer 100 according to an embodiment of the present invention, described below, includes a configuration in which detection is selected so that the detection is preliminarily performed using one of the IQ detection and the ASK detection (for example, the IQ detection) and a signal after the detection is demodulated. In addition, in the configuration, when the AGC control voltage level of the selected IQ detection reaches a value greater than or equal to a predetermined threshold value (X m [V]), detection is switched to the other detection (for example, the ASK detection).

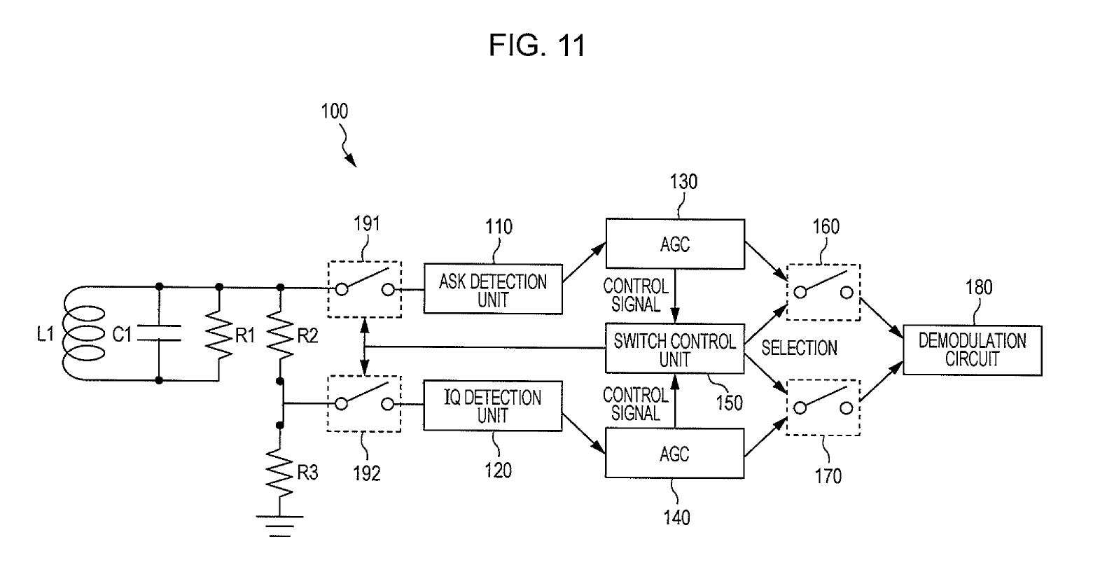

FIG. 11 is an explanatory diagram illustrating the configuration of the example of a modification to the reader/writer 100 according to an embodiment of the present invention. The example of a modification to the reader/writer 100 according to an embodiment of the present invention, illustrated in FIG. 11, includes a configuration in which switches 191 and 192 are added, compared with the reader/writer 100 according to an embodiment of the present invention, illustrated in FIG. 5.

For example, in the reader/writer 100 according to an embodiment of the present invention, illustrated in FIG. 11, at the time of a normal operation, the switch 191 is put into an off-state and the switch 192 is put into an on-state, and hence a signal received from the contactless IC card using the antenna coil L1 is subjected to IQ detection in the IQ detection unit 120, and a signal after the detection is demodulated in the demodulation circuit 180 in a subsequent stage.

In addition, when the switch control unit 150 detects that the AGC control voltage level of the IQ detection becomes a value less than the predetermined threshold value (X m [V]), the switch 191 is put into an on-state and the switch 192 is put into an off-state, and hence the signal received from the contactless IC card using the antenna coil L1 is subjected to ASK detection in the ASK detection unit 110, and a signal after the detection is demodulated in the demodulation circuit 180 in a subsequent stage.

By including such a configuration as described above, the reader/writer 100 according to an embodiment of the present invention, illustrated in FIG. 11, can select one of the IQ detection processing and the ASK detection processing on the basis of whether or not the AGC control voltage level of the IQ detection is less than the predetermined threshold value (X m [V]).

### 2. Summary

As described above, according to an embodiment of the present invention, a configuration is adopted in which both the IQ detection processing and the ASK detection processing are executed in the reader/writer 100, and switching between the IQ detection processing and the ASK detection processing is performed on the basis of whether or not the AGC control voltage level of the IQ detection is less than the predetermined threshold value.

In this way, a configuration is adopted in which both the IQ detection processing and the ASK detection processing are executed in the reader/writer 100, and switching between the IQ detection processing and the ASK detection processing is performed on the basis of whether or not the AGC control voltage level of the IQ detection is less than the predetermined threshold value. Accordingly, even at a communication distance causing the phase inversion NULL to occur, a communication error is solved and the decrease of a communication distance, associated with the dynamic range of the IQ detection, can be prevented. Furthermore, in the reader/writer 100 according to an embodiment of the present invention, compared with a technique disclosed in Japanese Unexamined Patent Application Publication No. 2009-175976, the phase inversion NULL can be improved without the Q-value being changed, and in addition, a method can be concurrently used in which the Q-value of the reader/writer is changed in order to improve communication quality.

In addition, the reader/writers 100 according to an embodiment of the present invention, illustrated in FIGS. 5 and 11, may be embedded in an electronic device such as a personal computer, an automatic ticket gate in a station, or the like. By embedding the reader/writer 100 in such an electronic device, contactless communication processing between the electronic device and the contactless IC card becomes available, and even at a communication distance causing the phase inversion NULL to occur, a communication error is solved and the decrease of a communication distance, associated with the dynamic range of the IQ detection, can be prevented.

In addition, switching between the IQ detection processing and the ASK detection processing, performed in the reader/writer 100 according to an embodiment of the present invention, may be executed using a computer program. When the above-mentioned switching between the IQ detection processing and the ASK detection processing is performed using the computer program, a medium in which the computer program is stored is stored in the reader/writer 100, and an arithmetic device such as a central processing unit (CPU) or the like may read out the computer program from the medium and execute the computer program.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a wireless antenna configured to perform contactless communication using electromagnetic coupling;
an IQ detection unit configured to subject a signal received by the wireless antenna to IQ detection;
an ASK detection unit configured to subject the signal received by the wireless antenna to ASK detection;
a first AGC circuit configured to control a gain for the signal subjected to the IQ detection by the IQ detection unit;
a second AGC circuit configured to control a gain for the signal subjected to the ASK detection by the ASK detection unit;
a demodulation circuit configured to perform predetermined demodulation processing on an output of the first AGC circuit or an output of the second AGC circuit; and
a control unit configured to receive information of control voltage levels from the first AGC circuit and the second AGC circuit, and control, in response to the information of the control voltage levels, supply of one of the outputs of the first AGC circuit and the second AGC circuit to the demodulation circuit, by switching between the outputs of the first AGC circuit and the second AGC circuit.

2. The information processing device according to claim 1, wherein
the control unit controls, on the basis of whether or not the control voltage level from the second AGC circuit is less than a predetermined threshold value, supply of one of the outputs of the first AGC circuit and the second AGC circuit to the demodulation circuit, by switching between the outputs of the first AGC circuit and the second AGC circuit.

3. The information processing device according to claim 2, wherein
the control unit controls the supply so that the output of the second AGC circuit is supplied to the demodulation circuit when the control voltage level from the second AGC circuit is less than a predetermined threshold value and the output of the first AGC circuit is supplied to the demodulation circuit when the control voltage level from the second AGC circuit is greater than or equal to the predetermined threshold value.

4. The information processing device according to claim 1, wherein
the control unit controls the supply so that the output of the second AGC circuit is supplied to the demodulation circuit when the control voltage level from the second AGC circuit is less than the control voltage level from the first AGC circuit and the output of the first AGC circuit is supplied to the demodulation circuit when the control voltage level from the second AGC circuit is greater than or equal to the control voltage level from the first AGC circuit.

5. The information processing device according to claim 4, wherein
the control unit controls the supply so that the control unit switches to an output, which has not been selected, and supplies the output to the demodulation circuit, when a demodulation error occurs in demodulation processing performed in the demodulation circuit.

6. The information processing device according to claim 1, further comprising:
a first switch configured to be provided between the first AGC circuit and the demodulation circuit; and
a second switch configured to be provided between the second AGC circuit and the demodulation circuit, wherein
the control unit switches between the outputs of the first AGC circuit and the second AGC circuit and supplies one of the outputs of the first AGC circuit and the second AGC circuit to the demodulation circuit, by switching over the first switch and the second switch.

7. The information processing device according to claim 1, further comprising:
a third switch configured to be provided between the wireless antenna and the first AGC circuit; and
a fourth switch configured to be provided between the wireless antenna and the second AGC circuit, wherein
the control unit switches between the outputs of the first AGC circuit and the second AGC circuit and supplies one of the outputs of the first AGC circuit and the second AGC circuit to the demodulation circuit, by switching over the third switch and the fourth switch.

8. A receiving method comprising the steps of:
performing contactless communication using a wireless antenna and electromagnetic coupling;
subjecting a signal received by the wireless antenna in the communication step to IQ detection;
subjecting the signal received by the wireless antenna in the communication step to ASK detection;
firstly automatically controlling a gain for the signal subjected to the IQ detection in the IQ detection step;
secondly automatically controlling a gain for the signal subjected to the ASK detection in the ASK detection step;
performing predetermined demodulation processing on an output of the first AGC step or an output of the second AGC step; and
receiving information of control voltage levels in the first AGC step and the second AGC step, and controlling, in response to the information of the control voltage levels, supply of one of the outputs of the first AGC step and the second AGC step to the demodulation step, by switching between the outputs of the first AGC step and the second AGC step.
